(19) United States
(12) Patent Application Publication
(10) Pub. No.: US 2004/0071173 A1
(43) Pub. Date: Apr. 15, 2004

(54) Mode hop detection system and method of detecting mode hops

(76) Inventor: Jianhong Huang, San Jose, CA (US)

Correspondence Address: LAW OFFICE OF ALAN W. CANNON, 834 SOUTH WOLFE ROAD, SUNNYVALE, CA, 94086, US

(21) Appl. No.: 10/272,216

(22) Filed: Oct. 15, 2002

(51) Int. Cl. H01S 3/13

(52) U.S. Cl. 372/29.02

(57) ABSTRACT

System and method for detection of mode hops in the output of continuously tunable lasers according to variation in the period of an interference signal derived from laser output. The method comprises generating an interference signal from laser output, detecting variation in the period of the interference signal, and determining the presence of a mode hop or mode hops from the detected variation in the period of the interference signal. The methods may additionally comprise adjusting the cavity of the laser when a mode hop is detected.

### FIELD OF THE INVENTION

The present invention relates to the field of continuously tunable lasers, and more particularly to systems and methods of tuning such laser systems with the assistance of mode hop detection.

### BACKGROUND OF THE INVENTION

Continuously tunable lasers have found increasing use for test and measurement applications, biomedical systems, optical characterization and quality control for wavelength sensitive components, and other uses. External cavity lasers that are tunable over a wide wavelength range by adjustment of a grating, prism, interference filter or other tuning element have been of particular interest. An important feature of continuously tunable external cavity lasers is operation without unwanted switching or hopping between laser cavity modes during tuning. Many systems have been developed to avoid such mode hops during the tuning of an external cavity laser by adjusting laser external cavity length during tuning. In grating-tuned external cavity lasers using the Littman-Metcalf configuration, for example, various systems have been developed to provide simultaneous rotational and translational adjustment of a reflective or retroreflective element with respect to a grating to provide mode-hop free operation during tuning. Exemplary tuning systems for Littman Metcalf external cavity lasers are disclosed in U.S. Pat. Nos. 5,319,668, 5,379,310, 5,594,744, 5,802,085 and 5,867,512.

In the manufacture of continuously tunable external cavity lasers, adjustments are typically made to ensure that the laser provides mode hop-free output over its entire tuning range. Mode hop detection is typically carried out by evaluating or scanning laser output with a wavelength meter as the laser is tuned over its tunable range. If a mode hop is detected, an adjustment may be made to the laser external cavity to correct the mode hop. In many external cavity lasers, such an adjustment will involve re-positioning of a diode gain medium. The laser output must be scanned over several operating temperatures and operating current or power levels to ensure mode hop-free operation under all conditions that will likely be experienced during commercial use of the laser. Each scan with a wavelength meter requires several minutes, and evaluation of a laser over a range of operating temperatures and pump current levels or laser output levels can take many hours or days. Further, when laser cavity adjustments are made to correct for detected mode hops, previous scans often must be repeated to ensure that the laser cavity adjustment has not introduced a mode hop under previously tested conditions.

Wavelength characterization of an external cavity laser using a wavelength meter in this manner is thus both time consuming and expensive, and can substantially increase the cost of laser manufacture. There is accordingly a need for a system and method for mode hop detection in laser output that can be quickly and easily carried out without the use of a wavelength meter. The present invention satisfies these needs, as well as others, and overcomes the deficiencies found in the background art.

### SUMMARY OF THE INVENTION

The present invention provides for mode hop detection in laser output according to variation in the period of an interference signal derived from laser output. The methods of the invention comprise, in general terms, generating an interference signal from laser output, detecting variation in the period of the interference signal, and determining the presence of a mode hop or mode hops from the detected variation in the period of the interference signal. The methods may additionally comprise adjusting the external cavity of the laser under test when a mode hop has been detected.

By way of example, and not of limitation, the generating of an interference signal may comprise directing laser output through an interference element to generate a periodic interference signal. The interference element may comprise one or more Fabry-Perot, Mach-Zender, Michaelson, Sagnac or other interferometers, which may be employed individually or arranged in series or in parallel. In many embodiments a Fabry-Perot etalon or interference filter may be used as an interference element. Generating an interference signal may further comprise passing output from the interference element to an optical to electrical converter to create an interference signal in the form of a voltage versus wavelength curve or plot.

Detecting variation in the period of the interference signal may comprise comparing the expected period of the interference signal to the observed period, and noting any differences between the expected and observed interference signals that arise due to mode hop events. More specifically, detection variation in the period of the interference signal may comprise comparing the distance between adjacent periodic maxima or minima in the interference signal and determining any difference in spacing between adjacent periodic maxima or minima in the interference signal.

Detecting of mode hops may comprise correlating changes of periodicity of the interference signal with laser output wavelength. This may be achieved in many embodiments by graphically plotting change in interference periodicity versus wavelength. The graphical representation of change in period of interference signal versus laser output wavelength reveals the presence of mode hops. Mode hop detecting may further comprise making any corrections in plot slope that arise from nonlinearity in the laser tuning mechanism.

Adjusting of the laser cavity to correct for detected mode hops may comprise positionally adjusting one or both end reflectors associated with a laser external cavity. In many embodiments a laser cavity end reflector will be present on the surface of a diode gain medium, and adjustment of the laser cavity may be achieved by positioning of the gain medium.

A system according to the present invention comprises, in general terms, an interference element positioned in the output beam of a continuously tunable external cavity laser and configured to generate a periodic sinusoidal interference pattern in the laser output, an optical to electrical converter positioned in the output beam after the interference element and configured to generate an interference signal according to the interference pattern created by the interference element, and a data processor with programming capable of detecting variations in the period of the interference signal and detecting mode hops from the period variations.

These and other objects, advantages, and features of the invention will become apparent to those persons skilled in the art upon reading the details of the invention as more fully described below.

### BRIEF DESCRIPTION OF THE DRAWINGS

A more complete understanding of the systems and methods of the present invention may be obtained by referring to the following detailed description together with the accompanying drawings, which are for illustrative purposes only.

FIG. 1 is a schematic representation of a mode hop detection system in accordance with the present invention.

FIG. 2A is a graphical representation of relative interference signal versus wavelength illustrating the detection of mode hops in laser output according to the present invention.

FIG. 2B is a graphical representation of measured periods in the interference signal versus wavelength which visually displays the detected mode hops.

FIG. 3 is a flow chart illustrating a method of detecting and correcting for mode hops according to the present invention.

FIG. 4A and FIG. 4B are exemplary visual interface displays that graphically illustrate etalon signal versus wavelength, together with corresponding graphical illustrations of change in period versus wavelength for the “peak period” and “valley period” of the etalon signal.

### DETAILED DESCRIPTION OF THE INVENTION

Disclosed herein are systems and methods for mode hop detection in laser output. The present invention provides rapid mode hop detection over wide tuning ranges. Before the present invention is described further, it should be understood that the invention is not limited to the particular embodiments of the invention described below, as variations of the particular embodiments may be made and still fall within the scope of the appended claims. It is also to be understood that the terminology employed is for the purpose of describing particular embodiments, and is not intended to be limiting. Instead, the scope of the present invention will be established by the appended claims.

It should also be noted that as used herein and in the appended claims, the singular forms “a”, “and”, and “the” include plural referents unless the context clearly dictates otherwise. Thus, for example, reference to “a module” includes a plurality of such module, and reference to “the query” includes reference to one or more queries and equivalents thereof known to those skilled in the art, and so forth.

Any publications discussed herein are provided solely for their disclosure prior to the filing date of the present application. Nothing herein is to be construed as an admission that the present invention is not entitled to antedate such publication by virtue of prior invention. The dates of publication provided may be different from the actual publication dates, which may need to be independently confirmed. All publications mentioned herein are incorporated herein by reference to disclose and describe the methods, systems or other subject matter in connection with which the publications are cited.

Any definitions herein are provided for reason of clarity, and should not be considered as limiting. The technical and scientific terms used herein are intended to have the same meaning as commonly understood by one of ordinary skill in the art to which the invention pertains.

With the above in mind, reference is made more specifically to the drawings which show the present invention embodied in a system and method of FIG. 14B. It will be appreciated that the systems may vary as to configuration and as to details of the parts, and that the methods may vary as to detail and the order of the events or acts, without departing from the basic concepts as disclosed herein. It will also be apparent that various functional components of the invention as described herein may share the same logic and be implemented within the same program or hardware elements, or in different program or hardware elements and configurations.

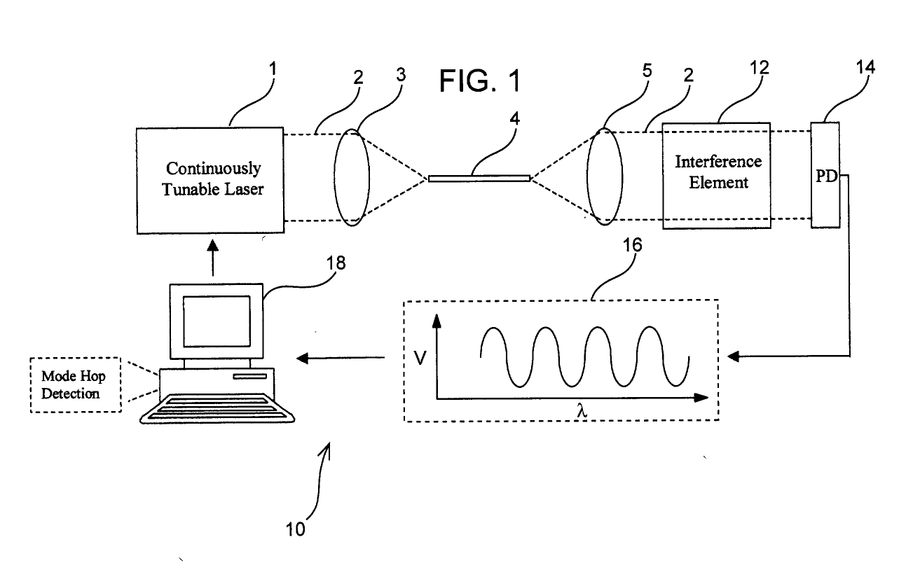

Referring now to FIG. 1, a schematic representation of a mode hop detection system 10 in accordance with the present invention is shown interfacing with a continuously tunable laser 1 for detection and correction of mode hops that may exist between laser cavity modes during tuning of the laser 1. System 10 includes an interference element 12 which is positioned across the output beam 2 of continuously tunable external cavity laser 1, such that as the output beam 2 passes through interference element 12, the interference element 12 generates a periodic sinusoidal interference pattern in the laser output beam. Interference element 12 may include at least one Fabry-Perot interferometers or at least one other known interferometer, such as a Mach-Zender, Michaelson, Sagnac or other interferometer. In the embodiment shown, interference element 12 is a Mach-Zender interferometer.

An optical to electrical converter 14 (such as photodiode, a photomultiplier-tube, or other component for converting optical signals to electrical signals) is positioned across the output beam of interference element 12 such that the output beam is converted to an electrical interference signal 16. The electrical interference signal can be plotted as a sinusoidal wave/curve with the amplitude of the curve indicating the voltage of the signal, which is plotted with respect to the wavelength of the laser beam being outputted.

System 10 further includes means for analyzing 18 the interference signal 16, to determine mode hops that may exist, by detecting variations in the periodicity of the interference signal. A variation in the periodicity in the interference signal indicates that a mode hop is occurring and gives a user of the present system an indication as to which way the cavity length of the external cavity laser 1 may need to be adjusted to eliminate the mode hop. The means for analyzing 18 may be embodied in the form of a computer or other electronic device or data processor employing hardware solutions, software solutions, or a combination of software and hardware to carry out the methods of detecting described herein.

FIG. 1 further shows a collimator 3 which is placed in the output beam 2 of laser 1 and used to focus the beam 1 into an optical fiber 4. Optical fiber 4 outputs the beam to a second collimator 5, which re-focuses the output beam onto interference element 12. It is noted that components 3, 4 and 5 are optional, in that the interference element 12 maybe directly interfaced with the output beam 2 of the laser 1 as it exits the laser 1 and still perform mode hop detection and correction according to the techniques provided herein.

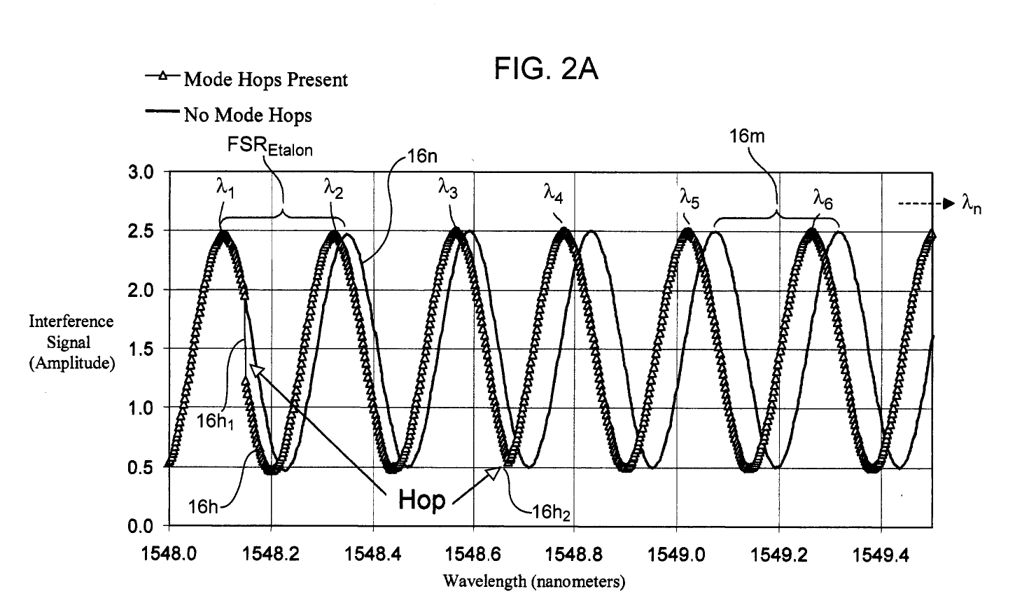

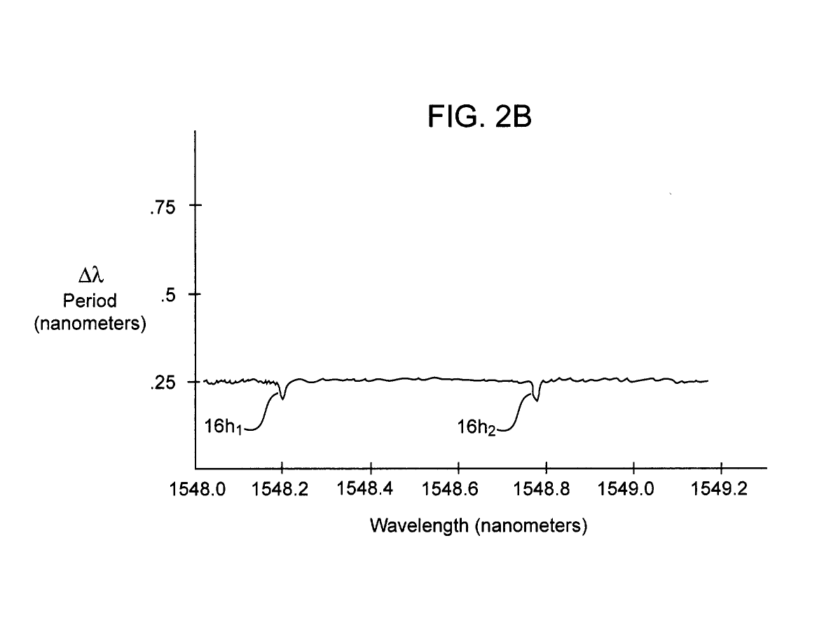

Referring now to FIG. 2A, a reproduction of a portion of an interference signal 16h which contains mode hops is shown, plotted for laser output wavelengths ranging from 1548.0 nanometers to 1549.4 nanometers. It is noted that this is only an exemplary portion of a total scan that is normally carried out to create an interference signal, which generally extends over a much larger wavelength range. Typical scans can range over a variation in wavelength of 100 nanometers or more, for example. Thus, only a portion of a typical scan is shown, as this is sufficient to explain the present invention, with the understanding that similar processing is applied over the reminder of the wavelengths making up the interference signal in a typical full scan procedure.

FIG. 2A also includes a plot of an interference signal 16n which has been generated using the same interference element 12 and under the same conditions as those used in generating interference signal 16h, except that the laser output characterized by interference signal 16n contains no mode hops. Note that the period of the sinusoidal wave 16n is determined by the free spectral range (FSR) of the interferometer/etalon used to generate the sinusoidal interference signal, as known to those of ordinary skill in the art. The period of the wave 16n can be calculated when the free spectral range of the interference element 12 is known. Also, the period can be directly measured from the plot of the interference signal 16n by measuring the distance between maxima 16m (or minima, or any consistent repeating location along the curve, i.e., points separated by 2π radians). Thus, the periodicity of the interference signal 16n can be characterized by the distance 16m between adjacent maxima in the curve.

When a mode hop occurs in the laser output 2 during scanning/tuning of the laser, a phase shift of the interference signal occurs, which is clearly visible in the representation of FIG. 2A when comparing signal 16h with signal 16n at locations 16h₁ and 16h₂. An up-hop (i.e., hop to a higher mode) decreases the period of the resulting interference signal, as shown by both of the aforementioned examples, whereas a down-hop (i.e., hope to a lower mode) increases the period of the resulting interference signal. For example, when using a Mach-Zender interferometer having a FSR of 33 GHz, a mode hop (3.3 GHz hop) creates a 10% phase shift. If the FSR of the interference element 12 is reduced to 6.6 GHz, a mode hop (0.66 GHz hop) creates a 50% period change. Such a large change increases the signal to noise ratio in the generated plots, thereby rendering it even easier to detect occurrences of mode hops.

An analysis of the periodicity of the interference signal 16h may be performed to determine the modalities (defined within a wavelength range) of the laser output where mode hops are occurring. Because a mode hop changes the phase of an interference signal as noted above, it is possible to measure the distance between peaks (maxima or minima) or any reoccurring location on the sinusoidal, and then comparing those distances to determine which ones are longer or shorter than the intended length which is determined by the free spectral range of the interference element being used. By plotting these distance values, a graphical display of the wavelength regions in which the hops are occurring can be produced, as well as the directionality of the hop (up or down) as will be described below.

As an example, if we assume that the distance 16m in FIG. 2A is 0.25 nm, then an interference signal produced which indicates no hops would be expected to have peaks at wavelengths each separated by a distance of 0.25 nm. However, because a mode hop (up-hop) has occurred at 16h₁, the distance between peaks λ₁ and λ₂ will be less than 0.25 nm due to the phase shift caused by the mode hop. On the other hand, since no mode hop is occurring between the wavelengths over which the curve between peaks λ₂ and λ₃ have been plotted, the distance between peaks λ₂ and λ₃ will be 0.25 nm. The distance between peaks 3 and 4 will also be less than 0.25 nm due to the phase shift cause by the up-hop at 16h₂. The distance between peaks λ₄ and λ₅, as well as between λ₅ and λ₆ will also be measured to be 0.25 nm, as no hops occur between each of these peaks. When the distance measurements are plotted against a wavelength scale, a graphical indication of the location (and directionality) of the hops is obtained, as will be described in further detail below.

Note that this method of characterizing the periodicity of the interference signal does not depend upon where, between the peaks, that the mode hop occurs. Regardless of where the mode hop occurs, the distance between the peaks that border the occurrence of the mode hop will be altered, as compared to the distance between a pair of peaks which bound a segment of the curve where no mode hops have occurred. Furthermore, the technique is also reliable for measurement between non-adjacent peaks. For example, by measuring the distance between λ₃ and λ₁, a distance measurement will be obtained that is less than a distance measured between peaks λ₇ and λ₅ (assuming that no modes hops have occurred between λ₆ and λ₇, as appears to be the case in FIG. 2A), indicating a mode hop somewhere between peaks λ₃ and λ₁, and likewise, the distance between λ₅ and λ₃ will also be less than the distance measured between peaks λ₇ and λ₅, indicating a mode hop somewhere between peaks λ₅ and λ₃. Of course, in practice, many more distance measurements between peaks would be obtained (out to λₙ), with the majority of the measured distances being equal to the distance between peaks λ₇ and λ₅. Therefore, by plotting these distances with respect to wavelength, the expected distances (showing no hops) form a baseline, from which the distance measurements that vary from the expected distance deviate and can be easily identified as locations characterizing mode hops.

In general, the characterization of periodicity by the above method can be determined by measuring a distance between recurring point locations on the interference signal according to the formula as follows:

Δλ=λₙ−λₙ₋ₘ

where:

Δλ is the distance measured between the two points (in nm for the example given in FIG. 2A);

λₙ is the wavelength of the first point in the measurement;

λₙ₋ₘ is the wavelength of the second point in the measurement;

n is a set of integers associated with wavelengths representing points on the interference signal successively separated by 2π radians each; and

m is a non-zero integer.

The present methods preferably characterize the periodicity of an interference signal by measuring distances between maxima or minima of the interference curve, because these points are inherently easier to identify. However, the current techniques are not limited to measuring between maxima or minima, as any recurring point locations on the interference curve could be used as measurement points (i.e., any points along the curve separated by n2π radians, as long as consistency in the measurement points is maintained.

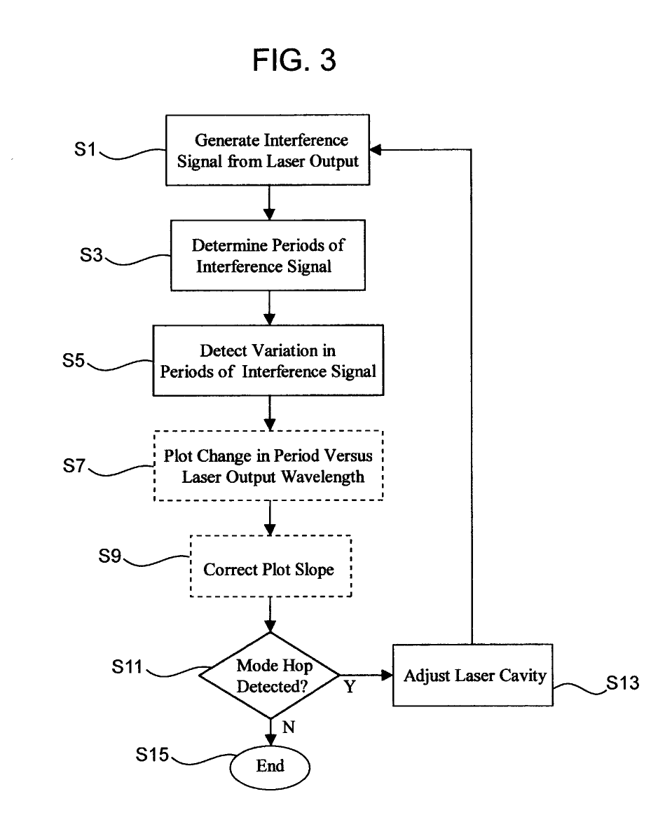

Referring now to FIG. 3, a flow chart illustrating a method of detecting and correcting for mode hops according to the present invention is shown. In step S1, an interference signal 16 is generated as described above with regard to FIG. 1. The interference signal is inputted to a computer or other electronic device 18 that includes software and/or hardware adapted to identify recurring point locations on the interference signal, so as to characterize the periodicity of the interference signal. For example, one embodiment of the present invention includes software that requests user input as to how many consecutive data points to sample at a time from the inputted interference signal for determining maxima (or minima) of the curve. A user may specify the number of consecutive data points to be no more than half of the half-width of one period of the interference signal. The number of points in a period of the interference signal depends on the data acquisition rate and the laser tuning speed.

After choosing the number of consecutive data points to sample, the software then samples the y-axis values (i.e., voltage values/amplitude) of the points and compares adjacent points to determine the larger value (for finding maxima) or smaller value (for finding minima). When a largest (or smallest, as the case may be) value has been identified, and the next values begin trending lower (or higher), a maximum (or minimum) for the curve has been identified, and the software stores the x-axis value of this point as a maximum (or minimum) wavelength. The comparison process then continues to identify the next maximum (or minimum) and this procedure continues until the entire wavelength spectrum that is being monitored has been sampled and compared.

Once all maxima (or minima or other recurring point locations) have been identified by their x-axis coordinates (wavelengths), the periodicity of the interference signal can be characterized in step S3. For example, in the case where maxima are identified, if the first maximum is at wavelength λ1, the second maximum is at λ₂, the third maximum is at λ₃ and the maximums continue all the way to λₙ, the periods of the interference signal can be defined by determining the distances between maxima. The system can therefore determine period distances according to the formula: Δλ=λₙ−λₙ₋ₘ as described above. For example, the user may choose m=1, where the system would then calculate the distances between λₙ−λₙ₋₁, λₙ₋₁−λₙ₋₂ . . . λ₃−λ₂, and λ₂−λ₁; which would give period distances for Δλₙ, Δλₙ₋₁, Δλₙ₋₂, . . . Δλ₃, and Δλ₂. By comparing the Δλ values, the system will determine that a majority of the values are substantially equal to the FSR of the interference element used, or substantially equal to one another (i.e., the FSR need not even be used as a comparator). Of course, there will be some degree of noise present with processing the signal values, and a threshold noise level will be considered within the normal range of “substantially equal”. However, those Δλ values that are determined to exceed the threshold noise level will be identified in step S5 to be indicative of a mode hop. Thus, the system can identify the maxima wavelengths between which a mode hop occurs by step S5. The threshold noise level should be less than about forty percent of the hop wavelength change. For example, for an interference signal having a period of 0.25 nm, where a mode hop produces a wavelength change in the period of 0.025 nm, the threshold noise level should be less than about 0.010 nm. By this example, any period measurements outside the range of 0.250±0.010 nm would indicate a mode-hop, i.e., any Δλ values below 0.240 nm or above 0.260 nm in this example would be identified as mode hops.

In addition to automatic detection of the mode hops by the system, the system can further optionally plot the measured period (i.e., “Δλ” values) against a wavelength value defining a period in which they are occurring at step S7. FIG. 2B shows an example of such a plot, which has been drawn to represent the mode hops detected in interference signal 16h (FIG. 2A). Note that a representation of the noise level is also shown, but that peaks at 1548.2 and 15.48.6 clearly shown the occurrence of mode hops. The convention used in this plot was to plot the measure period (Δλ) at the endpoint of the measured period, although this is only a convention that could be altered. For example, the period defining the distance between λ₁ and λ₂ (i.e., λ₂-λ₁) has been plotted at the wavelength for λ₂

Further manipulations in the characterization of the periodicity of the interference signal can be performed to deliver a plot which is even more intuitive for interpretation by the user. For example, the “baseline” of the plot can be repositioned to a value of substantially zero on the y-axis of the plot (“Δλ” value) by subtracting the expected period of the signal (based on the FSR of the interference element used) from each value that is plotted. This can also be done by simply referring to the value of the non-hop periods that has been established by the above measurements and which is plotted in FIG. 2B. Because an up-hop shortens the measured period, it appears as a downward signal in FIG. 2B, or a negative signal for a normalized plot where the baseline has been repositioned to zero. By plotting the negative of the Δλ values on the chart having the baseline at zero, this will show the peaks identifying up-hops as positive peaks and the peaks identifying down-hops as negative peaks, which is a visually intuitive representation of what is actually occurring during the testing of the laser that can be more easily interpreted by the user.

An anomaly that often occurs when plotting the periodicity of an interference signal versus wavelength, is a progressive sloping or “fading” of the period values plot as the wavelength of the interference signal increases. This anomaly is generally due to the rate of wavelength change versus tuning motor angle change not being constant at different angles (wavelengths), and because of this, it shows up not only when plotting according to the techniques of the present invention, but also when using currently known, conventional techniques. While this phenomenon does not effect the results of the mode hop detecting techniques according to the present invention, a further optional step is to correct for the slope of the periodicity plot, so that the plot is a substantially flat or horizontal plot (i.e., having a overall slope of substantially zero). To do this, the plot that includes the sloping data may optionally be manipulated, at step S9, to make a linear fit to make the data look substantially horizontal, such as by a least squares fitting technique or other known data normalizing technique. Note that the plot shown in FIG. 2B has already been normalized, so that sloping does not appear.

At step S11, a determination is made as to whether or not a mode hop has been detected. This determination can be made automatically by the computer software or hardware that has characterized the periodicity of the interference signal, may be determined manually after a visual observation of the periodicity plot by the user, or a combination of both. In any event, the identification of a hop by periodicity plotting gives the user an indication that an adjustment needs to be made to the laser cavity. As noted, the directionality of the peak (positive or negative) indicates whether the hop is an up-hop or a down-hop, and thus tells the user which direction the laser cavity needs to be adjusted in. Also, the number of hops may give some indication as to the amount of adjustment that needs to be made (e.g., 10 micron or 20 micron cavity length adjustment, etc.).

Assuming a mode hop is detected, the user next adjusts the laser cavity at step S13. If no mode hop is detected at step S11, then the testing phase under the current conditions has been completed, and the procedure ends at step S15. The procedure may be repeated, of course, for other temperature conditions, current or power levels, etc. Going back again to step S11, if a mode hop is detected, an adjustment of the laser cavity is performed at step S13. An example of an adjusting step would be to loosen the screws on a collimated diode block to allow repositioning of the block, repositioning the block, thereby changing the position of the reflective element on the block to adjust the cavity length to a more appropriate position, and retightening the screws to fix the new position of the block. Of course there are numerous different adjustment assemblies of modifying the laser cavity of an external cavity laser, and the present invention is not limited to any particular mechanism or method of adjustment. After completion of the adjustment, the laser is again tested, starting at step S1, whereby the laser is scanned through the entire wavelength range to be tested and an interference signal is again generated over that entire wavelength range.

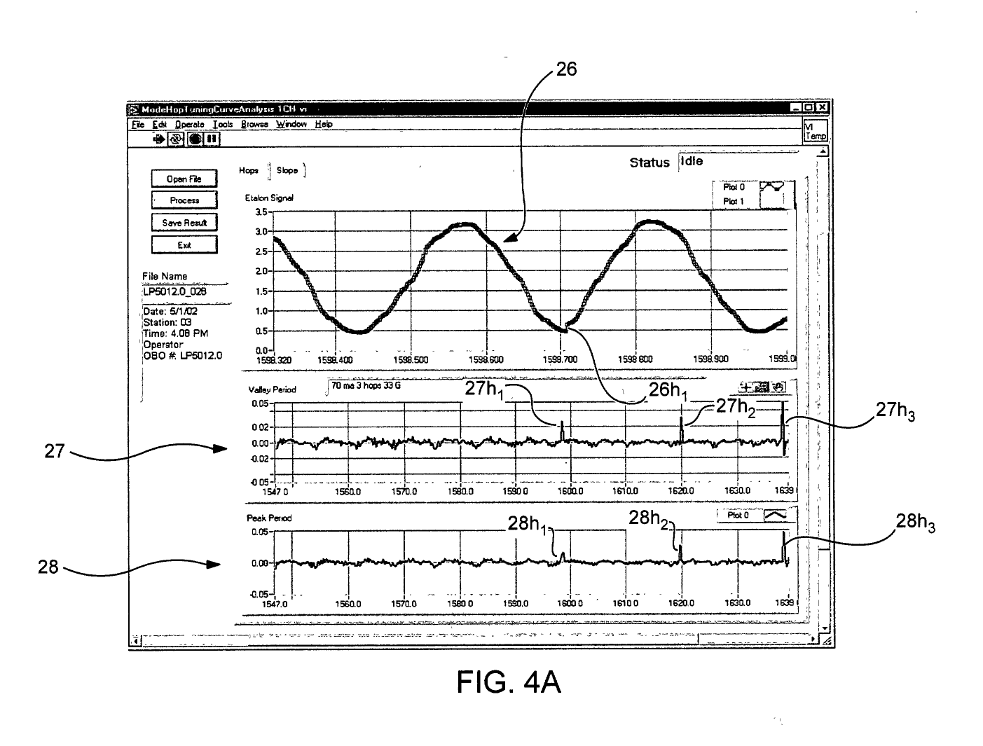

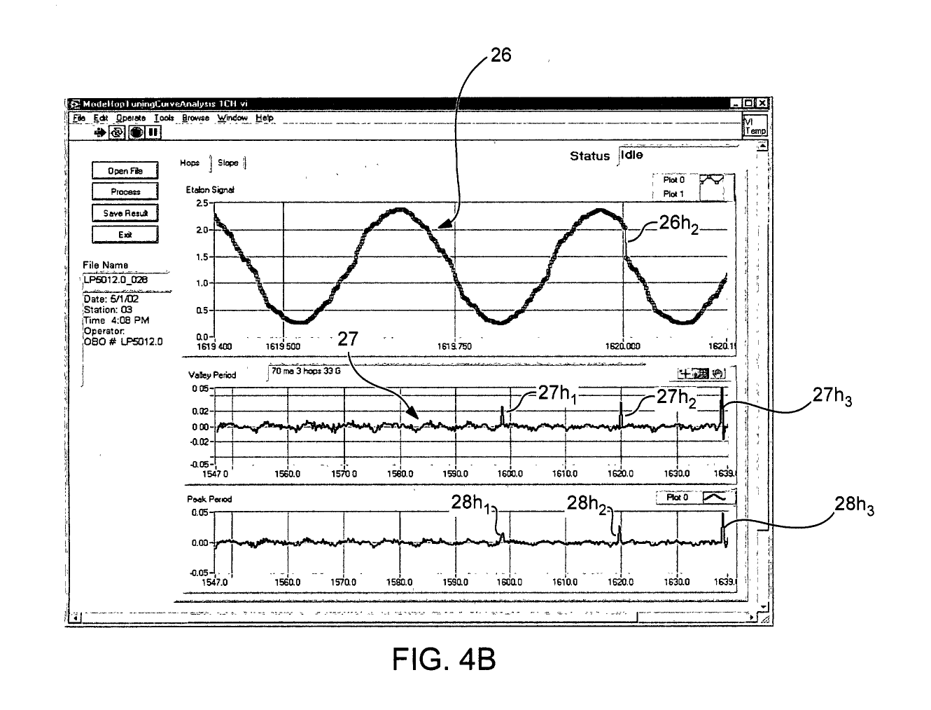

FIGS. 4A and 4B are exemplary visual interface displays that graphically illustrate etalon (i.e., interference) signal 26 versus wavelength, together with corresponding graphical illustrations of change in period versus wavelength for the “valley periods” 27 and the “peak periods” 28 of the interference signal 26, respectively. Plots 27 and 28 have been processed to establish baselines substantially at 0.00 nanometers and to establish a substantially horizontal slope of each plot according to the techniques described above. In FIGS. 4A and 4B, it can be observed that periodicity characterization by valley period 27 as well as by peak period 28 gives consistent identification of the mode hops occurring in the signal 26 both as to wavelength location as well as number of hops. For example, plots 27 and 28 each identify a first mode hop 27h₁, 28h₁, at about 1598.7 nanometers, which is also seen as a discontinuity 26h₁ in plot 26 (FIG., 4A). Both identified mode hops 27h₁,28h₁ have the same directionality (positive, i.e., indicating an up-hop), with respect to the general baseline of the plot. Similarly, plots 27 and 28 each identify a second mode hop 27h₂,28h₂ at about 1620.0 nanometers, which is also seen as a discontinuity 26h₂ in plot 26 (FIG. 4B). Both identified mode hops 27h₂,28h₂ have the same directionality (positive, i.e., indicating an up-hop), with respect to the baseline.

While the present invention has been described with reference to the specific embodiments thereof, it should be understood by those skilled in the art that various changes may be made and equivalents may be substituted without departing from the true spirit and scope of the invention. For example, other techniques for characterizing the periodicity of an interference signal have been developed by the present inventor although they have been found to be less desirable by virtue of being either less reliable, or more costly and space consuming. For example, using an arrangement as already described, mode hop detection can be accomplished by determining the slope of the interference signal when a sufficiently high rate of sampling of the signal is performed. A mode hop establishes a discontinuity in the interference signal which can be identified through a comparison of the slopes of the curve taken in the location of where the mode hop occurs. A problem with this technique, is that if a mode hop occurs on a peak or valley of the interference signal, the slope technique will not identify such a hop, as the slope is zero in these locations. A more reliable slope technique includes a pair of interference elements arranged perpendicular to one another so that two interference signals are generated ninety degrees out of phase with one another. By analyzing both interference signals, if a mode hop occurs on a peak or valley of one signal and is missed by slope analysis of that signal, the same mode hop cannot be on the peak or valley of the other interference signal since it is ninety degrees out of phase with the first interference signal. Therefore, by doing the slope analysis on the second signal, the mode hop that was missed on the peak or valley of the first signal will be identified. While this setup is reliable, it is more costly and space consuming, as it requires an additional beam splitter, interference element and optical to electrical converter, as well as more processing, and it takes up more table space.

In addition, many modifications may be made to adapt a particular situation, material, composition of matter, process, process step or steps, to the objective, spirit and scope of the present invention. All such modifications are intended to be within the scope of the claims appended hereto.

That which is claimed is:

1. A method for mode hop detection in laser output, comprising:
(a) generating an interference signal from said laser output,
(b) monitoring variation in periodicity of said interference signal; and
(c) determining presence of a mode hop from detected variation in periodicity of said interference signal.

2. The method of claim 1, further comprising adjusting laser cavity length to correct said mode hop.

3. The method of claim 1, wherein said generating said interference signal comprises positioning an interference element in a laser output beam, said interference element configured to produce a periodic variation in said output beam.

4. The method of claim 3, wherein said generating said interference signal further comprises positioning an optical to electrical converter in said output beam after said interference element.

5. The method of claim 4, wherein said monitoring variation in said periodicity comprises monitoring output from said optical to electrical converter.

6. The method of claim 1, wherein said monitoring variation in said interference signal comprises determining a difference in period between repeating signal features.

7. The method of claim 6, wherein said repeating signal features comprise adjacent maxima in said interference signal.

8. The method of claim 6, wherein said repeating signal features comprise adjacent minima in said interference signal.

9. The method of claim 6, wherein said determining said difference in period between said signal features in said interference signal comprises determining a value for the relationship
Δλ=λₙ−λₙ₋ₘ
where:
Δλ is a distance measured between the two points;
λₙ is the wavelength of the first point in the measurement;
λₙ₋ₘ is the wavelength of the second point in the measurement;
n is a set of integers associated with wavelengths representing points on the interference signal successively separated by 2π radians each; and
m is a non-zero integer.

10. The method of claim 6, wherein said determining said difference in period between said signal features in said interference signal comprises determining a value for the relationship
λₙ−λₙ₋₁
wherein λₙ is a wavelength associated with a first signal feature, λₙ₋₁ is a wavelength associated with a second, adjacent signal feature.

11. The method of claim 1, wherein said determining presence of said mode hop comprises determining a relationship between change in periodicity of said interference signal and wavelength.

12. The method of claim 11, further comprising correcting plot slope for said change in periodicity of said interference signal versus wavelength.

13. The method of claim 2, wherein said adjusting said laser cavity comprises positionally adjusting an end reflector of said laser cavity.

14. A mode hop detection system, comprising:
(a) an interference element positioned in a laser output beam, said interference element configured to generate an interference pattern in said laser output beam;
(b) an optical to electrical converter positioned in said laser output beam after said interference element, said optical to electrical converter configured to generate an interference signal according to said interference pattern; and
(c) a data processor operatively coupled to said optical to electrical converter and configured to detect variation in periodicity of said interference signal.

15. The system of claim 14, wherein said data processor further comprises programming configured to detect mode hops from said variation in periodicity of said interference signal.

16. The system of claim 15, wherein said programming comprises means for determining a relationship between change in periodicity of repeating features in said interference signal and wavelength of said repeating features in said interference signal.

17. The system of claim 15, wherein said repeating features are adjacent features.

18. The system of claim 17, wherein said repeating features are maxima.

19. The system of claim 17, wherein said repeating features are minima.
